(19) United States
(12) Patent Application Publication
(10) Pub. No.: US 2017/0185608 A1
(43) Pub. Date: Jun. 29, 2017

(54) App Onboarding System For Developer-Defined Creation Of Search Engine Results

(71) Applicant: Quixey, Inc., Mountain View, CA (US)

(72) Inventors: Nofar LEVI, Hod HaSharon (IL); Tomer KAGAN, Sunnyvale, CA (US); Mor SCHLESINGER, Ramat Hasharon (IL); Kalyan DESINENI, Mountain View, CA (US); Naor ROSENBERG, Elyakhin (IL)

(21) Appl. No.: 15/245,250

(22) Filed: Aug. 24, 2016

Related U.S. Application Data
(63) Continuation of application No. 14/980,763, filed on Dec. 28, 2015.

(51) Int. Cl. G06F 17/30

(52) U.S. Cl. CPC G06F 17/3087; G06F 17/30876

(57) ABSTRACT

A search system includes a user interface configured to receive information about a first application from a developer of the first application. The search system includes a state access module configured to obtain information about a first type of state of the first application from the developer. The information includes an action performed by the first type of state, a first access URL template, and a designation of at least one parameter for the first access URL template. The first application is configured to display a specific state of the first type of state in response to receiving an access URL formed by instantiating the first access URL template with at least one value for the at least one parameter. The search system includes a search engine configured to, in response to a query, obtain data from the first application according to the information about the first type of state.

### CROSS-REFERENCE TO RELATED APPLICATIONS

The present application is a continuation of U.S. patent application Ser. No. 14/980,763 filed on Dec. 28, 2015. The entire disclosure of the application referenced above is incorporated by reference.

### FIELD

The present disclosure relates to mobile search systems and more particularly to indexing and returning results from mobile applications.

### BACKGROUND

Search engines are an integral part of today's electronic world. A search engine is generally powered by a collection of search indices. A search index may associate key words or combinations of key words to particular locations (such as web pages) containing or related to those key words. In order to generate and maintain these search indices, search engines often use crawlers to find and identify documents and extract information from the documents. A web crawler requests a document (a web page) from the web server and indexes key words in the document. Web page metadata and heuristics may allow the crawler to recognize the importance or semantic meaning of various aspects of the document.

As the world transitions to more and more content being available through mobile platforms and some content only being available through mobile platforms, search engines increasingly rely on content from applications and not just content from web pages. Some native apps, such as the Uber ride sharing app, do not even have a corresponding web presence. However, with the wide variety of applications, and the nearly infinite ways in which content can be assembled and presented in these apps, recognizing and interpreting data from apps is very difficult for a search engine.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A search system includes a user interface configured to receive information about a first application from a developer of the first application. The search system includes a state access module configured to obtain information about a first type of state of the first application from the developer via the user interface. The information includes an action performed by the first type of state of the first application. The information includes a first access uniform resource locator (URL) template. The information includes a designation of at least one parameter for the first access URL template. The first application is configured to display a specific state of the first type of state in response to receiving an access URL formed by instantiating the first access URL template with at least one value for the at least one parameter. The search system includes an emulator configured to execute a copy of the first application and send a first access URL to the first application. The first access URL is formed by instantiating the first access URL template with test data. The emulator obtains information about a resulting state of the first application. The state access module is configured to verify that the resulting state is the first type of state based on the information about the resulting state. The search system includes a search engine configured to obtain data from the first application according to the information about the first type of state and selectively provide the obtained data in response to a query from a user of the search system.

In other features, the query from the user is an implicit query derived from content with which the user is interacting. The search engine is configured to transmit an advertisement to the user based on the obtained data. In other features, the search system includes a crawler configured to determine a set of access URLs, each access URL of the set being an instantiation of the first access URL template with different values for the at least one parameter. The crawler is configured to acquire content from each of the set of access URLs. The crawler is configured to store the content in a data store. The search engine consults the data store to respond to the queries from the users of the search system.

In other features, the emulator is configured to provide information about user interface (UI) elements from the resulting state to the user interface. The search system includes a state mapping module configured to receive data from the developer indicating which ones of the UI elements to include in a search result for the resulting state sent to the users of the search system. In other features, the state mapping module is configured to generate a preview of a search result for the resulting state and provide the preview to the developer for approval. The search result includes text and at least one image corresponding to the resulting state.

In other features, the state mapping module is configured to receive semantic meaning information from the developer for at least one of the UI elements. In other features, the state access module is configured to obtain a specification of an industry vertical for the first type of state of the first application, select a predetermined set of actions according to the specified industry vertical, and present the predetermined set of actions to the developer for selection of the action. In other features, the search system includes a digital distribution platform interface configured to acquire information about the first application from a digital distribution platform.

In other features, the search system includes an application management module configured to generate a search result for the first application based on the information about the first application. The search result includes text and at least one image. The search engine is configured to selectively provide the search result for the first application in response to the first application being relevant to a query. In other features, the application management module is configured to provide a preview of the search result to the developer for approval. The digital distribution platform interface is configured to acquire the copy of the first application from the digital distribution platform.

A method of operating a search system includes receiving information about a first application from a developer of the first application through a user interface. The method includes obtaining information about a first type of state of the first application from the developer via the user interface. The information includes an action performed by the first type of state of the first application. The information includes a first access uniform resource locator (URL) template. The information includes a designation of at least one parameter for the first access URL template. The first application is configured to display a specific state of the first type of state in response to receiving an access URL formed by instantiating the first access URL template with at least one value for the at least one parameter. The method includes executing a copy of the first application. The method includes sending a first access URL to the copy of the first application. The first access URL is formed by instantiating the first access URL template with test data. The method includes obtaining information about a resulting state of the first application. The method includes verifying that the resulting state is the first type of state based on the information about the resulting state. The method includes, in response to a query from a user of the search system, (i) obtaining data from the first application according to the information about the first type of state and (ii) selectively providing the obtained data to the user.

In other features, the query from the user is an implicit query derived from content with which the user is interacting. The providing the obtained data includes transmitting an advertisement to the user based on the obtained data. In other features, the method includes determining a set of access URLs, each access URL of the set being an instantiation of the first access URL template with different values for the at least one parameter. The method includes acquiring content from each of the set of access URLs and storing the content in a data store. The providing the obtained data to the user includes consulting the data store.

In other features, the method includes providing information about user interface (UI) elements from the resulting state to the user interface. The method includes receiving data from the developer indicating which ones of the UI elements to include in a search result for the resulting state sent to the user of the search system. In other features, the method includes generating a preview of a search result for the resulting state and providing the preview to the developer for approval. The search result includes text and at least one image corresponding to the resulting state.

In other features, the method includes receiving semantic meaning information from the developer for at least one of the UI elements. In other features, the method includes obtaining a specification of an industry vertical for the first type of state of the first application, selecting a predetermined set of actions according to the specified industry vertical, and presenting the predetermined set of actions to the developer for selection of the action. In other features, the method includes acquiring information about the first application from a digital distribution platform.

In other features, the method includes generating a search result for the first application based on the information about the first application. The search result includes text and at least one image. The method includes selectively providing the search result for the first application to a user in response to the first application being relevant to a query from the user. In other features, the method includes providing a preview of the search result to the developer for approval. The method includes acquiring the copy of the first application from the digital distribution platform.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a combined functional block diagram and example user interface of mobile search results.

FIG. 2 is a functional block diagram of an example search system.

FIG. 3A is a graphical representation of an example app state record format.

FIG. 3B is a graphical representation of an example app state record based on the format of FIG. 3A.

FIG. 4A is a graphical representation of an example app record format.

FIG. 4B is a graphical representation of an example app record based on the format of FIG. 4A.

FIG. 5 is a functional block diagram of access mapping with example data.

FIG. 6 is a functional block diagram of an example implementation of a developer portal.

FIG. 7 is a graphical example of data interchange between a developer and a developer portal.

FIGS. 8A-8F are example user interface screens for a developer portal.

FIG. 9 is a flowchart of example operation of the developer portal.

FIG. 10 is a flowchart of example operation of app state processing within the developer portal.

In the drawings, reference numbers may be reused to identify similar and/or identical elements.

### DETAILED DESCRIPTION

Companies interested in obtaining, indexing, and surfacing content from mobile applications (referred to interchangeably as “apps” in this disclosure) often have to apply a manual process to each app of interest. These companies may be providing search results to users directly or through an aggregator, may be providing content to social networks, and/or may be generating advertisements. These companies are described as search providers in this disclosure, even though the results of the search may be displayed as advertisements or social network content instead of explicit search results. In other words, the principles of the present disclosure apply to standard search, advertisements, and social networking content.

A search provider may first need to identify which apps are available and which apps might be of interest to users of the search system. The search provider then has to obtain data about the app, characterize functionality of the app, determine how to reach content of interest within the app, and determine how to interpret content that is retrieved.

With a manual or semi-manual process, even experienced search operators are limited in how many apps can be onboarded to a search system and how quickly those apps can be onboarded. The editions of an app for different operating systems may require separate onboarding processes. Further, as new versions of apps are released, the onboarding process may need to be at least verified if not updated or redone.

This limits the number of apps that can be encompassed by a search system and therefore limits the amount of information available to a user of the search system. Further, without deep insight into the app, an operator may not identify all of the relevant functionality, states, or available parameters in the app. Further, recognizing and classifying what types of data are displayed in any given state may be subject to errors. For example, a manual operator may misidentify a date shown within a state as the last update of that state, while the actual meaning of the date is the creation of that state.

Even when the operator recognizes the semantic meaning of data within states and identifies the relevant functionality of an app, the way in which results related to that app are displayed might not be the way the developer of the app would have expected or preferred. A developer may want to increase the exposure of their app and therefore hope to get the app incorporated into the search system more quickly and to have updates processed more rapidly than if solely relying on the search system's algorithms. However, if the app is not yet extremely popular, the limited resources of the search system may not be applied to that app.

The developer may also, for aesthetic or branding reasons, want to control how results from their app are presented to users of the search system. According to the present disclosure, a developer portal is implemented to allow a developer to submit an app for onboarding into a search system and assist the search system in identifying functionality, navigation parameters, and available states of the app. Further, the developer portal may allow the developer to identify user interface elements corresponding to information that can be shown in search results and/or used in indexing to identify relevant search results.

The developer may even apply semantic tags to elements of their application so that the meaning or significance of the various elements of the app is understood by the search system. The developer may be able to review and revise the search system's understanding of the app based on the developer-provided information. The developer may also be permitted to exert control over what and how information is displayed in search results. For example, search results may be provided in a Deep View Card (“DVC”) format.

A DVC for an app or a state of an app shows additional information, not just the identification of the app or app state. For example, the information may include a title of the app state or a description of the app state, which may be a snippet of text from the app state. Other metadata may be provided from the app state, including images, location, number of reviews, average review, and status indicators. For example, a status indicator of “open now” or “closed” may be applied to a business depending on whether the current time is within the operating hours of the business.

Some DVCs may emphasize information that led to the DVC being selected as a search result. For example, text within the DVC that matches a user's query may be shown in bold or italics. The DVC may also incorporate elements that allow direct actions, such as the ability to immediately call an establishment or to transition directly to a mapping app to get navigation directions to the establishment.

Other interactions with the DVC (such as tapping or clicking any other area of the DVC) may take the user to the indicated state or app. As described in more detail below, this may be accomplished by opening the relevant app or, if the app is not installed, opening a website related to the desired app state. In other implementations, an app that is not installed may be downloaded, installed, and then executed in order to reach the desired app state.

In other words, a DVC includes identifying information for the app or state as well as additional content from the app or state itself. The additional content allows the user to make a more informed choice about which result to choose, and it may even allow the user to directly perform an action without having to navigate to the app state. If the action the user wants to take is to obtain information, in some circumstances, the DVC itself may provide the necessary information to accomplish such action.

Based on the developer's semantic tagging of elements of the developer's app, the search system may automatically construct one or more DVCs based on predetermined templates. The developer may review the DVCs to ensure that the app data has been correctly understood by the search system. The developer may also be permitted to rearrange elements in a DVC and apply formatting to areas of the DVC. For example, the developer may be able to specify borders, shading, font type, and font colors.

Once the developer specifies to the developer portal what functions of the app should be onboarded into the search system, the search system may crawl the app to identify all of the individual states associated with these identified functions. Data may be extracted from these states and indexed by the search system to be returned to search users from the developer's app. If the developer updates the app, the developer portal may allow the developer to quickly upload or otherwise obtain the new version of the app and specify any changes to the app specifications in the search system. For example, new functionality may have been added and therefore a new set of states may be specified to the search system.

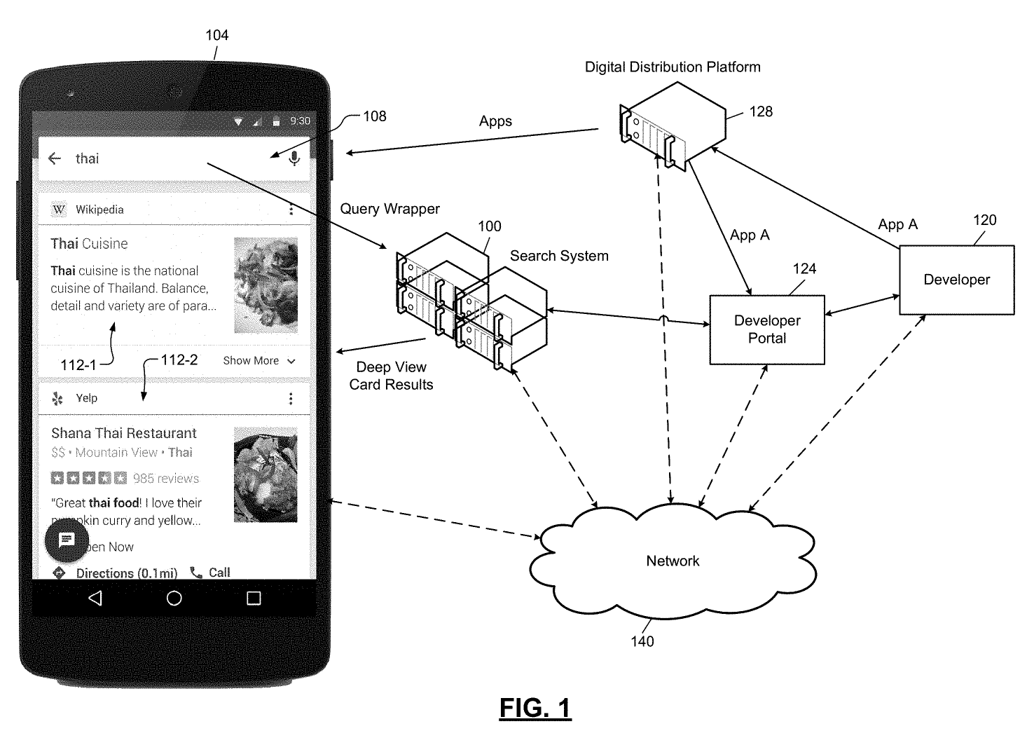

FIG. 1 shows a search system 100 providing results to a user device 104. The user device 104 is depicted as a smart phone, but could be any other type of user device, such as a laptop, tablet, smartwatch, or desktop computer. Search functionality may be built into an operating system of the user device 104, into a launcher app installed on the user device 104, into a search-system-specific app, or, using a Software Development Kit (SDK), into any other app designed to offer search functionality.

In one example, a text box 108 allows a user to type, speak, or paste text. This text is sent in a query wrapper to the search system 100. The search system 100 responds to the user device 104 with results, which may be in the form of DVCs. For example, a query for “Thai” may return a first DVC 112-1 for the WIKIPEDIA online encyclopedia app and a second DVC 112-2 for the YELP restaurant app. The first DVC 112-1 is related to information about Thai cuisine, while the second DVC 112-2 is directed to a specific restaurant having “Thai” in the name, the reviews, and in the designated cuisine of the restaurant.

The metadata that allowed the DVCs 112-1 and 112-2 to be returned as relevant results, and to be displayed as DVCs, may have been determined by a manual operator on behalf of the search system 100, or by developers of the respective apps. For example, a representative developer 120 interacts with a developer portal 124 to provide information about an app to the search system 100. An example app, app A, is provided to a digital distribution platform 128 by the developer 120.

The digital distribution platform 128 distributes apps to devices such as the user device 104. Popular digital distribution platforms include the GOOGLE PLAY digital distribution platform from Google Inc. and the APP STORE digital distribution platform from Apple Inc. The developer 120 communicates to the developer portal 124 that app A should be onboarded into the search system 100.

The developer portal 124 may acquire app A from the digital distribution platform 128. The developer portal 124 may also acquire information from the digital distribution platform 128, such as the title of the app, the developer name, user reviews, screenshots, logos, update history, popularity, etc. While the data flow in FIG. 1 is shown with solid lines, the systems in FIG. 1 may actually communicate with each other via network 140. The network 140 may include wired and wireless local area networks, personal area networks, and wide area networks such as the Internet.

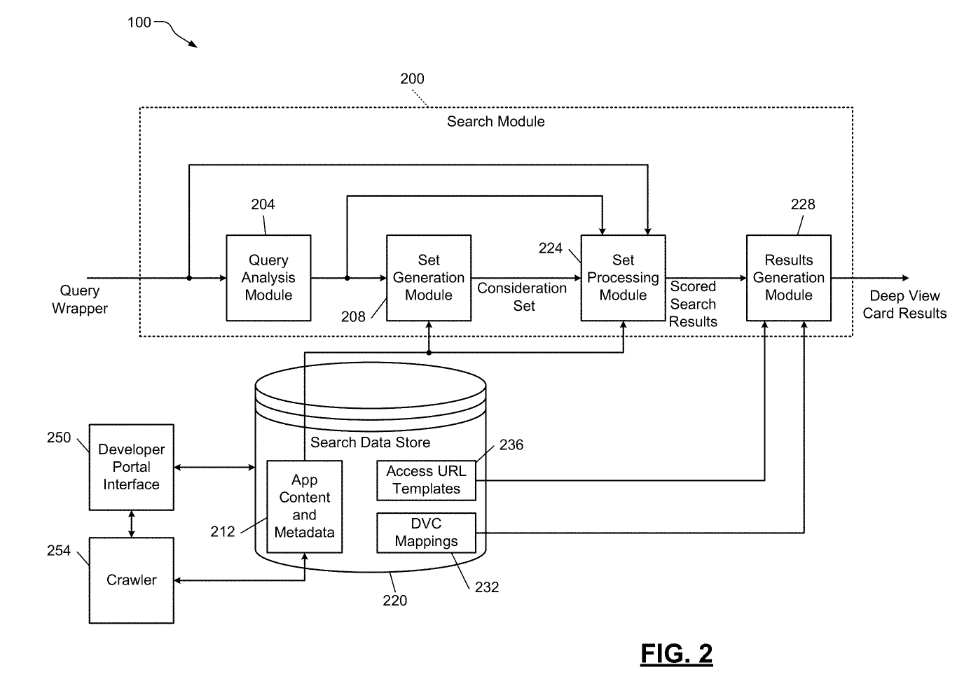

In FIG. 2, an example implementation of the search system 100 includes a search module 200. A query analysis module 204 receives a query wrapper and analyzes text within the query to identify query tokens, perform word stemming, identify synonyms, and remove stop words. The text in the query may be have been typed by a user with an explicit search. Alternatively, such as when the query is used to generate an advertisement, the query is implicit, not relying on text specifically typed by the user. Instead, the query includes contextual information to allow a relevant advertisement to be generated: for example, the title of the state of an app the user is viewing, keywords relating to the state, etc.

The query analysis module 204 may also analyze additional context data provided in the query wrapper, such as location, operating system version, etc. The query analysis module 204 provides potential parses of the query to a set generation module 208.

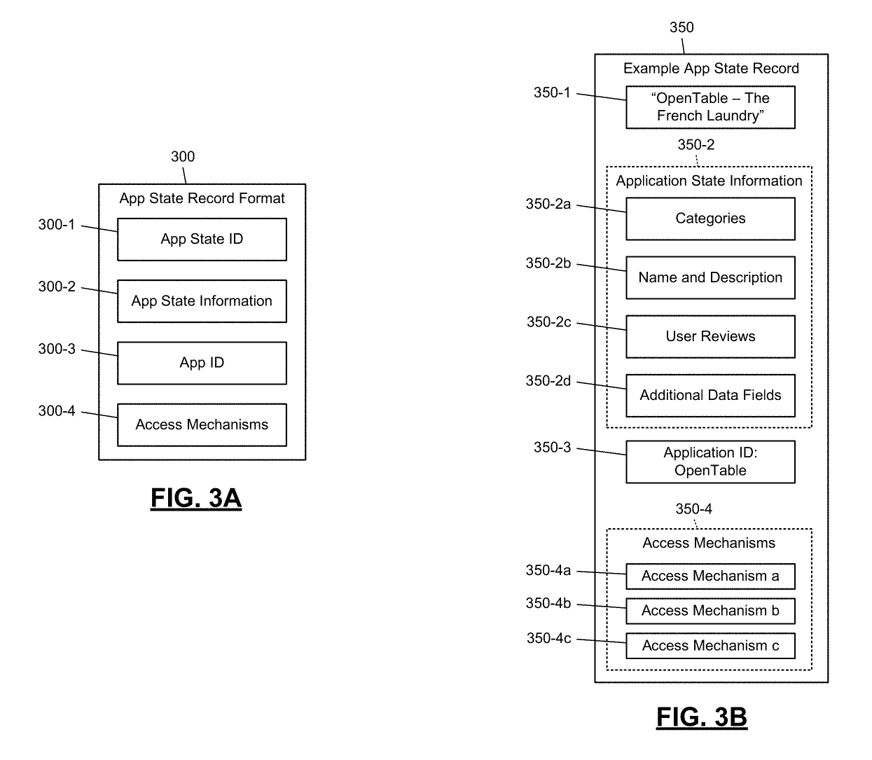

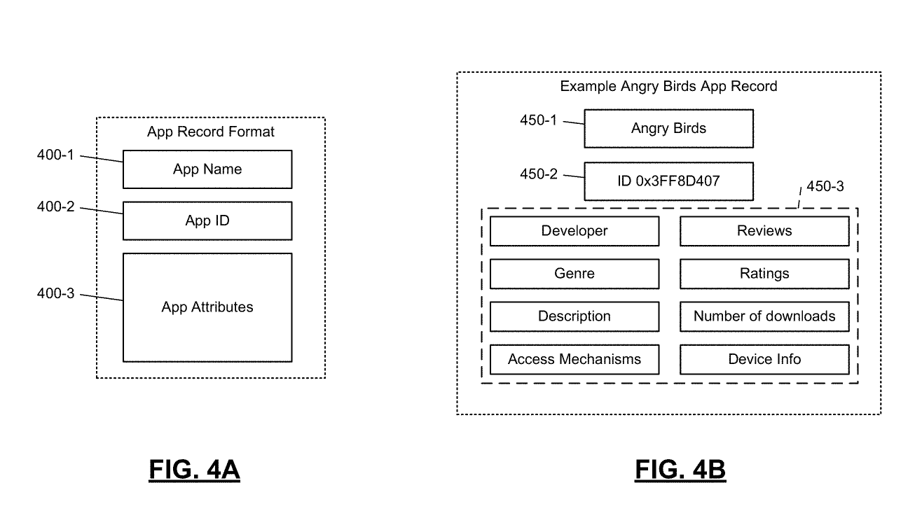

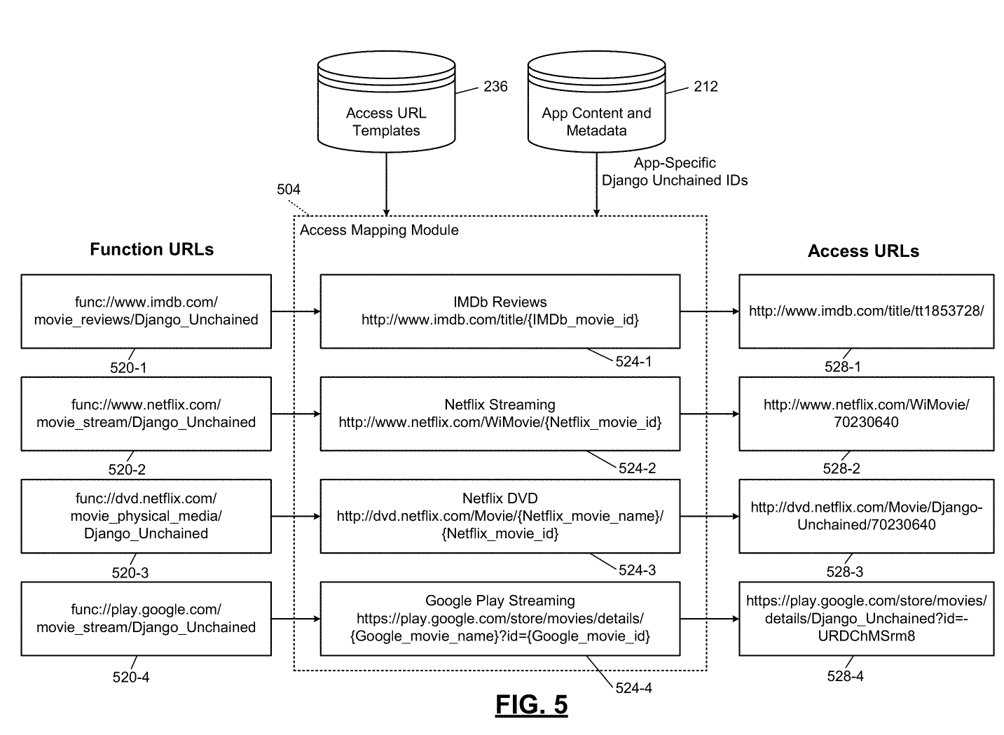

The set generation module 208 identifies a consideration set of app records and/or app state records. A state refers to a screen of an app, which may provide one or more different functions. Meanwhile, an app record, as described in more detail below, identifies the overall app itself. The set generation module 208 may operate using app content and metadata 212 from a search data store 220. The app content and metadata 212 may include records for apps, described in more detail below in FIG. 4A and FIG. 4B, and also for app states, described in more detail below in FIG. 3A and FIG. 3B. Metadata may include information about how popular the app is or how often results from that app are selected by users.

The set generation module 208 provides a set of the most relevant app and app state records to a set processing module 224. The set processing module 224 may calculate scores indicating the likelihood of relevance of the result to the search query. This relevance may be calculated based on the query parses from the query analysis module 204 as well as raw data from the query wrapper, such as location. In addition, the set processing module 224 may use app content and metadata 212. For example, all of the text associated with an app or app state may be used in calculating a score, while only a subset of the text is indexed and used to generate the consideration set.

Scored search results, or at least the highest-scored search results, are provided to a results generation module 228. The results generation module 228 prepares results for sending to the requester. For example, the requester may be a user device or may be a search aggregator retrieving results on behalf of a user device. The results generation module 228 may prepare DVCs based on DVC mappings 232, determining which fields of each state or each app are presented in a DVC.

Further, each result may be associated with one or more access mechanisms. For example, an access mechanism may allow the corresponding app to be opened to the specific app state for app state results or to a home state for an app result. If the app is not installed, an access mechanism may include a script to download the app from a digital distribution platform. Alternatively, if the app is not installed, not available, etc., a web access mechanism may also be present, which may direct the user to a web edition of the app.

For some apps that have been specifically developed to understand deep links (that is, links to specific states of an app), an access URL (Uniform Resource Locator) may be passed to the app. Parameters within the access URL instruct the app to open a specific state. Access URL templates 236 are stored in the search data store 220 and used to generate an access URL as the access mechanism or one of the access mechanisms for each result.

A developer portal interface 250 receives information about apps from the developer portal 124 and updates the app content and metadata 212, the DVC mappings 232, and the access URL templates 236. The developer portal interface 250 also interfaces with a crawler 254, which crawls states of the apps that have been onboarded into the search system 100.

The crawler 254 provides information from each crawled state to the app content and metadata 212 portion of the search data store 220. For example only, the crawler 254 may operate based on states identified by a developer using the developer portal interface 250. The states of interest identified by the developer, and in some implementations, the user interface interactions required to reach those states, may serve as guides for the crawler 254. For more information for guided crawling, and crawling in general, see commonly-assigned U.S. application Ser. No. 14/868,294 filed Sep. 28, 2015, titled Operator-Guided Application Crawling Architecture, with first-named inventor Kalyan Desineni, the entire disclosure of which is incorporated by reference.

In FIG. 3A, an example of an app state record format 300 includes an app state identifier (ID) 300-1, app state information 300-2, an app identifier (ID) 300-3, and one or more access mechanisms 300-4. The app state ID 300-1 may be used to uniquely identify the app state record in the search data store 220. The app state ID 300-1 may be a string of alphabetic, numeric, and/or special (e.g., punctuation marks) characters that uniquely identifies the associated app state record 300. In some examples, the app state ID 300-1 describes the application state in a human-readable form. For example, the app state ID 300-1 may include the name of the application referenced in the access mechanisms 300-4.

In a specific example, an app state ID 300-1 for an Internet music player application may include the name of the Internet music player application along with the song name that will be played when the Internet music player application is set to the specified state. In some examples, the app state ID 300-1 is a string (or triplet as discussed below) formatted similarly to a uniform resource locator (URL), which may include an identifier for the application and an identifier of the state within the application. In other implementations, a URL used as the app state ID 300-1 may include an identifier for the application, an identifier of an action to be provided by the application, and an identifier of an entity that is the target of the action.

For example only, see FIG. 3B, which shows an example app state record 350 associated with the OPENTABLE application from OpenTable, Inc. The OPENTABLE application is a restaurant-reservation application that allows users to search for restaurants, read reviews, and make restaurant reservations. The example app state record 350 of FIG. 3B describes an application state of the OPENTABLE application in which the OPENTABLE application accesses information for a specific entity: THE FRENCH LAUNDRY restaurant, a Yountville, Calif. restaurant. An app state ID 350-1 for the example app state record 350 is shown as “OpenTable—The French Laundry.”

Another implementation of the displayed app state ID 350-1 is based on a triplet of information: {application, action, entity}. The triplet for the example app state record 350 may be {“OpenTable”, “Show Reviews”, “The French Laundry”}. As mentioned above, this triplet may be formatted as a URL, such as the following: “func://www.OpenTable.com/Show_Reviews/The_French_Laundry.” Note that a different namespace is used (“func://”) to differentiate from the standard web namespace (“http://”), as the URL-formatted ID may not resolve to an actual web page. For example only, the OpenTable website may use a numeric identifier for each restaurant in their web URLs instead of the human-readable “The_French_Laundry.”

Continuing with FIG. 3A, the app state information 300-2 may include data that describes an app state into which an application is set according to the access mechanisms 300-4. The data types included in the app state information 300-2 may depend on the type of information associated with the app state and the functionality specified by the access mechanisms 300-4. The app state information 300-2 may include a variety of different types of data, such as structured, semi-structured, and/or unstructured data. The app state information 300-2 may be automatically and/or manually generated and updated based on documents retrieved from various data sources, which may include crawling of the apps themselves.

In some examples, the app state information 300-2 includes data presented to a user by an application when in the app state corresponding to the app state record 300. For example, if the app state record is associated with a shopping application, the app state information 300-2 may include data that describes products (such as names and prices) that are shown in the app state corresponding to the app state record 300. As another example, if the app state record is associated with a music player application, the app state information 300-2 may include data that describes a song (such as by track name and artist) that is played or displayed when the music player application is set to the specified app state.

When the app state record corresponds to a default state of an application, the app state information 300-2 may include information generally relevant to the application and not to any particular app state. For example, the app state information 300-2 may include the name of the developer of the application, the publisher of the application, a category (e.g., genre) of the application, a text description of the application (which may be specified by the application's developer), and the price of the application. The app state information 300-2 may also include security or privacy data about the application, battery usage of the application, and bandwidth usage of the application. The app state information 300-2 may also include application statistics, such as number of downloads, download rate (for example, average downloads per month), download velocity (for example, number of downloads within the past month as a percentage of total downloads), number of ratings, and number of reviews.

In FIG. 3B, the example app state record 350 includes app state information 350-2 for THE FRENCH LAUNDRY restaurant, including a restaurant category field 350-2a, a name and text description field 350-2b, user reviews field 350-2c, and additional data fields 350-2d.

The field 350-2a may include multiple categories under which the restaurant is categorized, such as the text labels “French cuisine” and “contemporary.” The field 350-2b may include the name of the restaurant (“The French Laundry”) and text that describes the restaurant. The field 350-2c may include text of user reviews for the restaurant. The field 350-2d may include additional data for the restaurant that does not specifically fit within the other defined fields, such as a menu, prices, and operating hours.

Continuing with FIG. 3A, the app ID 300-3 uniquely identifies an application associated with the app state record 300. For example, a value for application ID 350-3 in the app state record 350 uniquely identifies the OpenTable application. The application ID 350-3 may refer to a canonical OpenTable software product that encompasses all of the editions of the OpenTable application, including all the native versions of the OpenTable application across platforms (for example, IOS and ANDROID operating systems) and any web editions of the OpenTable application.

The access mechanisms 300-4 specify one or more ways that the state specified by the app state record can be accessed. For any given user device, only some of the access mechanisms 300-4 may be relevant. For illustration, the example app state record 350 depicts three access mechanisms 350-4, including access mechanism “a” 350-4a, access mechanism “b” 350-4b, and access mechanism “c” 350-4c.

For example, the access mechanism 350-4a may include a reference to a native IOS operating system edition of the OPENTABLE application along with one or more operations to be performed by the user device. For example, the access mechanism 350-4a may include an application resource identifier for the native iOS edition of the OPENTABLE application and one or more operations that navigate to the state in the OPENTABLE application for THE FRENCH LAUNDRY restaurant.

The access mechanism 350-4b may include a reference to a native ANDROID operating system edition of the OPENTABLE application along with one or more operations to be performed by the user device to navigate to the state in the ANDROID OPENTABLE application for THE FRENCH LAUNDRY restaurant. The access mechanism 350-4c may include a reference to a web edition of the OPENTABLE application, such as a URL that corresponds to a web page for THE FRENCH LAUNDRY restaurant on the OPENTABLE web site.

In FIG. 4A, an example of an app record format 400 includes an app name 400-1, an app identifier (ID) 400-2, and app attributes 400-3. The app record format 400 generally represents data relevant to a data store for a specific app. A data store may include thousands or millions of records having the structure specified by the app record format 400. The app ID 400-2 uniquely identifies an app in the data store. The app ID 400-2 may be assigned by the search system 100 and may therefore be independent of any ID assigned by, for example, a digital distribution platform.

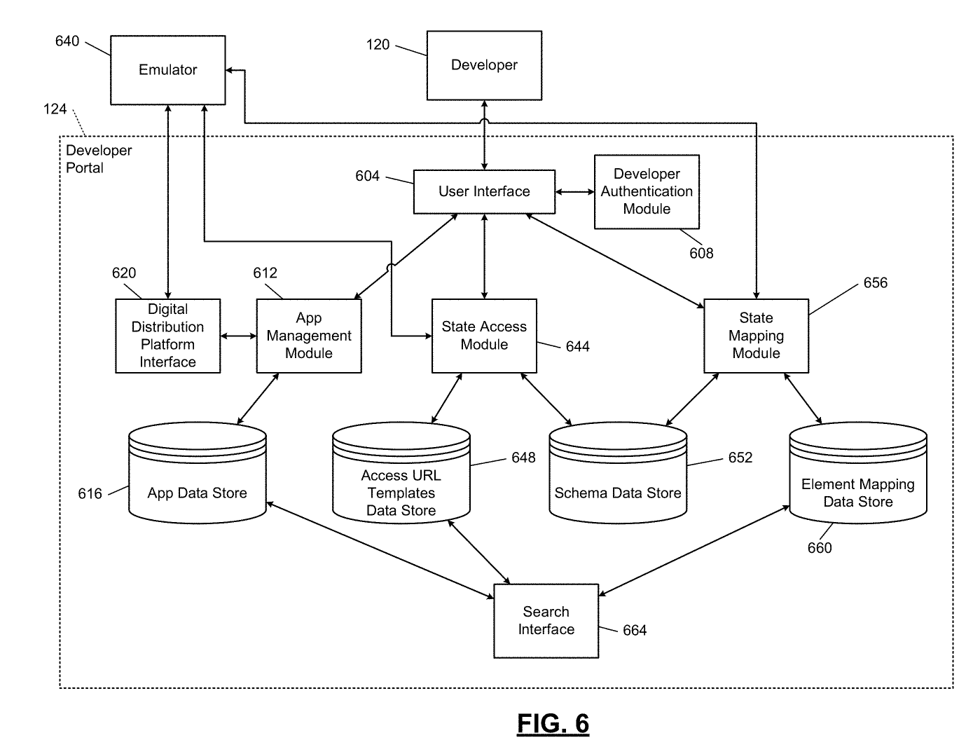

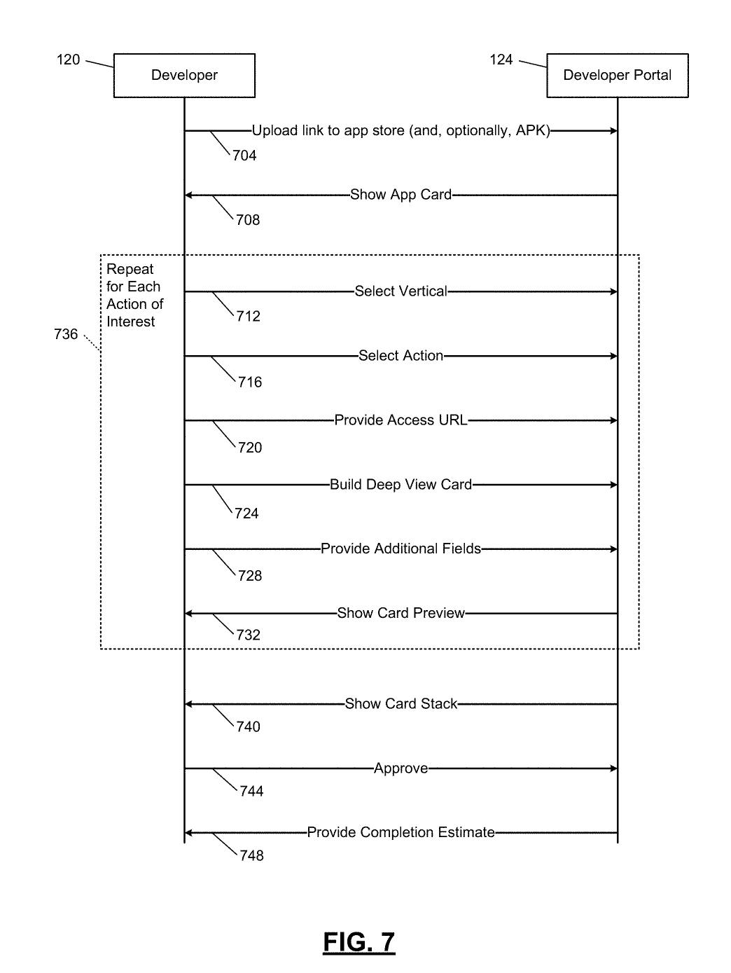

A single value for the app ID 400-2 may cover multiple app editions. The term “edition” applies to multiple versions of a single software product and may also apply to versions of that software product released for alternative operating systems. For example only, Angry Birds (as shown in FIG. 6B) may be available on Android and iOS mobile device platforms and, for each platform, may have a series of versions as bug fixes are released and as the app is updated to take advantage of, and to adapt to, newer versions of operating system. For some or all of the states, the software product may also have a web edition, which may be accessed using a browser.

In FIG. 4B, an example app record 450 for an ANGRY BIRDS app includes a name 450-1 of “Angry Birds” and a unique ID 450-2 expressed in hexadecimal as 0x3FF8D407. Attributes 450-3 for Angry Birds may include a name of the developer of Angry Birds, text reviews of Angry Birds, a genre indicator for Angry Birds (such as “Games,” or sub-genre “Physics-Based Games”), ratings (such as star ratings) for Angry Birds, a textual description (which may be provided by the developer), a number of downloads (which may be restricted to the most recent edition or could be for all editions), access mechanisms (how to open Angry Birds when already installed or how to install Angry Birds when not yet installed), and device info (for example, minimum requirements of operating system, hardware, and resolution for best operation).

In some examples, a single software product can provide more than one function. For example, a restaurant reservation app may also allow a user to read user reviews for a restaurant in addition to making reservations. As another example, a media player app may also allow a user to perform searches for digital media, purchase digital media, generate media playlists, and share media playlists.

The functions of a software product may be accessible using native app editions of the software app and/or web app editions of the software app. A native edition (or, “native application”) is, at least in part, installed on a user device. In some scenarios, a native app is installed on a user device but accesses an external resource (e.g., a database server) to obtain data from the external resource. For example, social media apps, weather apps, news apps, and search apps may respectively be accessed by one or more native apps that execute on various user devices.

In other scenarios, a native app is installed on the user device and does not access any external resources. For example, some gaming apps, calendar apps, media player apps, and document viewing apps may not require a connection to a network to perform a particular function. In these examples, the functionality of the software product is encoded in the native app itself.

Web editions (also referred to as “web applications”) of a software may be partially implemented by a user device (such as by a web browser executing on the user device) and partially implemented by a remote computing device (such as a web server or app server). For example, a web app may be an app that is implemented, at least in part, by a web server and accessed by a web browser native to the user device. Example web apps include web-based email, online auctions websites, social-networking websites, travel booking websites, and online retail websites. A web app accesses functions of a software product via a network.

When rendering a set of app search results, a user device displays a set of user-selectable links that can be selected by a user of the user device. A user-selectable link may include one or more underlying access mechanisms. A user-selectable link, when selected by a user, causes the user device to access a software product using an edition of the software app identified by the access mechanism.

Examples of access mechanisms include native access mechanisms, web access mechanisms, download access mechanisms, and scripts. A native access mechanism may be a string that includes a reference to a native app and indicates one or more operations for the user device to perform. If a user selects a user-selectable link including the native access mechanism, the user device may launch the corresponding native app.

In some implementations, any combination of the operating system of the user device, a search app executed by the user device, a native app executed by the user device, and/or a web browser executed by the user device can launch the native app referenced in the native access mechanism.

A web access mechanism may be a resource identifier that includes a reference to a web resource (e.g., a page of a web application/website), such as a uniform resource locator (URL) used with hypertext transfer protocol (HTTP). If a user selects a user-selectable link including a web access mechanism, the user device may launch a web browser app and may pass the resource identifier to the web browser.

An app download access mechanism may indicate a location (such as a digital distribution platform) where a native app can be downloaded in the scenario where a native app edition of the app is not installed on the user device. If a user selects a user-selectable link including an app download access mechanism, the user device may access a digital distribution platform from which the referenced native app edition may be downloaded. The user may opt to download the native app edition. Upon installation, the user device may automatically launch the native app edition.

A script access mechanism is a set of instructions that, when executed by the user device, cause the user device to access a resource indicated by the script. For example, the script may instruct an operating system of the user device to: launch a digital distribution platform interface app; browse to the specified native app within the digital distribution platform interface app; install the specified native app; and then open the specified native app.

In FIG. 5, an access mapping module 504 converts functional URLs into access URLs. Each app state within the search engine may be uniquely identified with a binary or hexadecimal number. In other implementations, a state may be uniquely identified by an information triplet—specifying the app, the function the app is to perform, and the entity on which the function will be performed—that uniquely identifies the state and carries intrinsic data as well. Each app or app state in a consideration set may be specified as a functional URL. The name “func://” differentiates a functional URL from a standard worldwide web URL in the “http://” scheme.

An access URL can be passed by an operating system to an app, which parses the access URL to determine which state of the app should be opened. The access URL may then require certain app-specific data, which may not be present in the internal functional URL representation. In addition, the format of the access URL may not always track the format of the functional URL. An access URL template allows a functional URL to be mapped to an access URL. Access URL templates 236 may be stored in the search data store 220 of FIG. 2.

In some circumstances, and as illustrated in FIG. 5, app-specific data may be required to instantiate an access URL using the access URL template. The metadata, such as an app-specific ID, may be retrieved from the app content and metadata 212 in the search data store 220 of FIG. 2. Fictitious functional URLs 520-1, 520-2, 520-3, and 520-4 (collectively, functional URLs 520) are converted using fictitious access URL templates 524-1, 524-2, 524-3, and 524-4 (collectively, access URL templates 524) into access URLs 528-1, 528-2, 528-3, and 528-4 (collectively, access URLs 528).

The functional URL 520-1 indicates the IMDB movie data app, specifies that the function is movie reviews, and specifies that the entity on which the function will be performed is the movie Django Unchained. The corresponding access URL template 524-1 specifies a parameterized URL including a parameter called imdb_movie_id. This parameter may be supplied from the app content and metadata 212 based on the specific ID for Django Unchained from the IMDb app.

The access URL 528-1 can be passed to an operating system of a user device. The operating system, if IMDb has registered to handle this domain, will pass the access URL 528-1 to the IMDb app, at which point the IMDb app recognizes its IMDb movie ID and opens movie review for Django Unchained.

In FIG. 6, an example implementation of the developer portal 124 includes a user interface 604, such as a web page. The developer 120 may access the user interface 604 and authenticate to the developer portal 124 based on a developer authentication module 608. The developer authentication module 608 may store credentials for the developer 120 and verify that another entity is not posing as the developer 120.

Credentials may be stored according to best practices, such as by adding a cryptographic salt value to the credentials and using a strong hashing function, such as PBKDF2 (Password-Based Key Derivation Function 2). Once a set of credentials has been connected to a specific name, manual intervention from a system administrator of the developer portal 124 may be necessary to change which entity is associated with that name.

Via the user interface 604, the developer 120 identifies an app to be onboarded to the search system 100. The app management module 612 may create a new record in an app data store 616 when the developer 120 identifies a new app. When the developer 120 identifies an existing app, the app management module 612 may retrieve data related to the app from the app data store 616.

The app specified by the developer 120 may be identified by a link (such as a URL) to a digital distribution platform. Based on the link, a digital distribution platform interface 620 may contact the corresponding digital distribution platform and download the specified app. In other implementations, the developer 120 may directly provide the app to the developer portal 124.

The developer 124 may verify that the app uploaded by the developer 120 matches the app present at the digital distribution platform. In some geographies, there may be a canonical digital distribution platform for each operating system. For example, in the United States, the Google Play digital distribution platform may be selected as the canonical location, where the app provided by the developer 120 should match the latest version of the app at the Google Play digital distribution platform. This ensures that a majority of users will be accessing the same edition of the app as is being onboarded to the search system 100.

The digital distribution platform interface 620 may also acquire data related to the specified app. For example, this data may include hidden metadata as well as the data available to regular users of the digital distribution platform. For example, the following data may be obtained and then stored in the app data store 616: name of the app, name of the app developer, text reviews, numeric rating, version history, download count, supported operating system versions, etc.

After downloading the app, the digital distribution platform interface 620 may provide the app to an emulator 640, which emulates an operating system capable of executing the app. The app is installed into the emulator 640, which allows the developer portal 124 to manipulate the app such as with user interface events and API (Application Programming Interface) calls, and study results and screenshots from the app.

Using a state access module 644, the developer can specify which functions are available within the app and how to access those functions. Accessing functions may be performed with access URLs, and an access URL template for each function may be stored in an access URL templates data store 648. In some implementations, accessing a state may require user interface events, and these user interface events may be recorded and stored in the access URL templates data store 648.

In other implementations, an API call (referred to as an intent in the ANDROID operating system) may be used to navigate to a particular state. These intents may also be stored in the access URL templates data store 648. The state access module 644 prompts the developer 120 to indicate what parameters are needed to populate the access URL. For example, one parameter may be an integer, while another is a floating point latitude and longitude of a location. Other parameters may include book titles, cuisine types, and names of events.

The developer 120 may be prompted by the state access module 644 to specify which industry vertical (referred to interchangeably as “verticals” in this disclosure) the function applies to. Available verticals, such as dining, film, transportation, etc., may be stored in a schema data store 652. Each possible vertical may have a variety of possible functions or actions to find in the schema data store 652. If the app function does not fit into one of the verticals, the developer 120 may suggest a new vertical for inclusion in the schema data store 652. Similarly, the developer 120 can suggest new actions or functions for supplementing the schema data store 652.

The state access module 644 may generate or request test data to instantiate an access URL from the parameterized access URL template. The state access module 644 then passes the access URL into the emulator 640 to open the executing copy of the app to the corresponding state. The state access module 644 verifies that the access URL does not produce an error and returns expected results. For example, expected results may be verified by presenting a screenshot from the emulator 640 to the developer 120.

A state mapping module 656 allows the developer 120 to define which user interface (UI) elements in a state of the app should be used for presenting results (such as deep view cards) and, in some implementations, which UI elements should be used by the search system to identify results. Further, the mapping module 656 may allow the developer to indicate semantic meaning of UI elements to the developer portal 124.

For example, the developer 120 may indicate that a certain UI element corresponds to a title of a restaurant, another UI element corresponds to a numeric rating of the restaurant, another UI element corresponds to a summary of textual reviews for the restaurant, etc. The semantic tags applied by the developer 120 may be specified by the schema data store 652 and may be based on which vertical had been selected. For example, the characteristics of a restaurant may be different than the characteristics of a book.

An element mapping data store 660 stores the semantic meaning of elements and also stores any indication by the developer 120 of which portions of an app state should be reflected in a search result. For example, the developer 120 may specify the layout of a deep view card (DVC) using various UI elements from a state. The state mapping module 656 may present a screenshot of a state from the emulator 640 based on the representative access URL used for testing by the state access module 644.

The state mapping module 656 may present a set of schema tags that can be dragged onto elements of the screenshot. In other implementations, the state mapping module 656 may allow the developer 120 to click a user interface element in the screenshot and select from a list of semantic tags. In the other implementations, the app developer 120 can drag UI elements from the screenshot of the app to semantic tags, which may be listed or shown in a tree hierarchy. Clicking and dragging from the screenshot may mean that the screenshot includes a map of pixel locations and a mapping between the pixel locations and UI elements scraped by the emulator 640.

In other implementations, the emulator 640 may produce a list of UI elements that is provided to the state mapping module 656, which then generates a copy of the screen of the app using the constituent UI elements. A search interface 664 updates the search system 100 with data from the app data store 616, the access URL templates data store 648, and the element mapping data store 660.

In FIG. 7, some of the data exchanged between the developer 120 and the developer portal 124 is demonstrated. While FIG. 7 is oriented with time increasing from top to bottom, some of the data exchanges can be reordered without violating the principles of the present disclosure. At 704, the developer uploads a link to an app store identifying the app. The developer 120 may also optionally upload a binary file of the app itself, such as an APK (Android Package) file.

The developer portal 124 prepares a proposed app card which will be shown to a search system user in response to the app being a relevant search result. The app card is provided by the developer portal 124 at 708. At 712, the developer 120 selects a vertical for a function of the app. At 716, the developer specifies the function (also known as an action). At 720, the developer 120 provides an access URL by which the action can be accessed. At 724, the developer 120 builds a deep view card for presenting a result from a state of the app. Building the deep view card may include specifying which user interface elements of the state should be shown in a DVC, where they should be located, and how they should be formatted.

At 728, the developer 120 may provide additional fields. These additional fields may not be presented within the DVC, but they may be useful in creating an index of the app states or in identifying relevant search results. For example, additional fields for a restaurant industry vertical may include hours of operation. The hours of operation may not be shown in some DVCs, but they may still be useful in determining whether the state is relevant to a search for restaurants open at the present time.

At 732, the developer portal 124 shows a card preview for the selected action. While not shown in FIG. 7, the developer 120 may adjust the deep view card if the preview is not satisfactory. As indicated by a dashed box 736, data exchanges 712, 716, 720, 724, 728, and 732 may be repeated for each action of interest. Once the developer 120 has specified all of the actions for the app, the developer portal 124 shows a stack of cards to the developer 120 at 740. The developer 120 provides final approval for the card stack at 744, including the app card and the one or more deep view cards.

At 748, the developer portal 124 provides a completion estimate to the developer 120. The completion estimate indicates when it is expected that the app will have completed the onboarding process. This may require specifying crawling strategy for the app to acquire individual state data corresponding to each deep view card. This may also involve updating search indices to reflect the content of the new app.

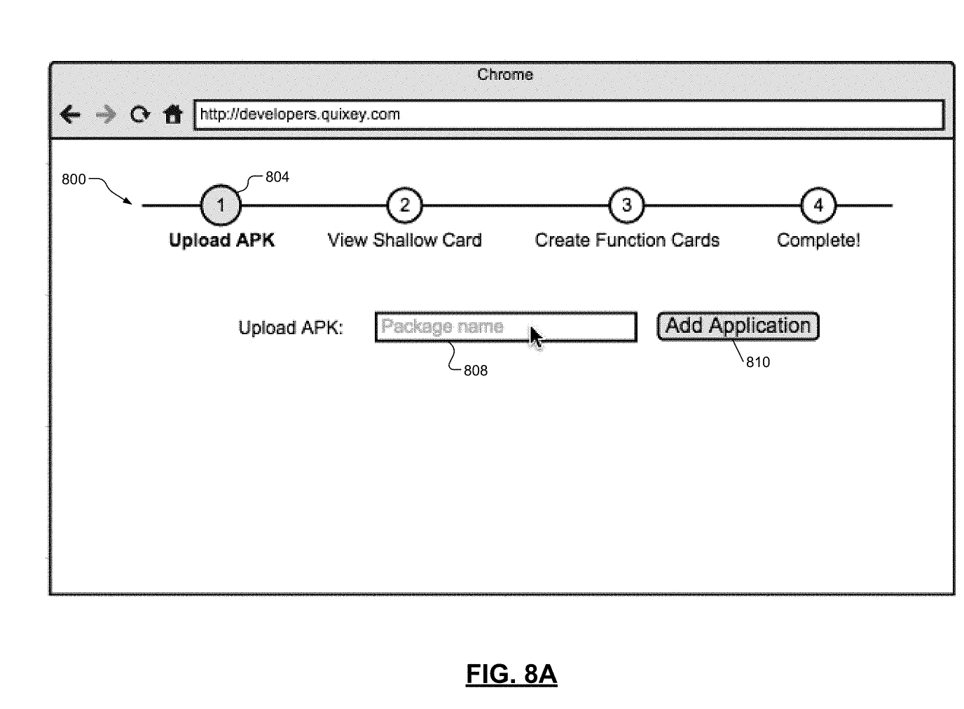

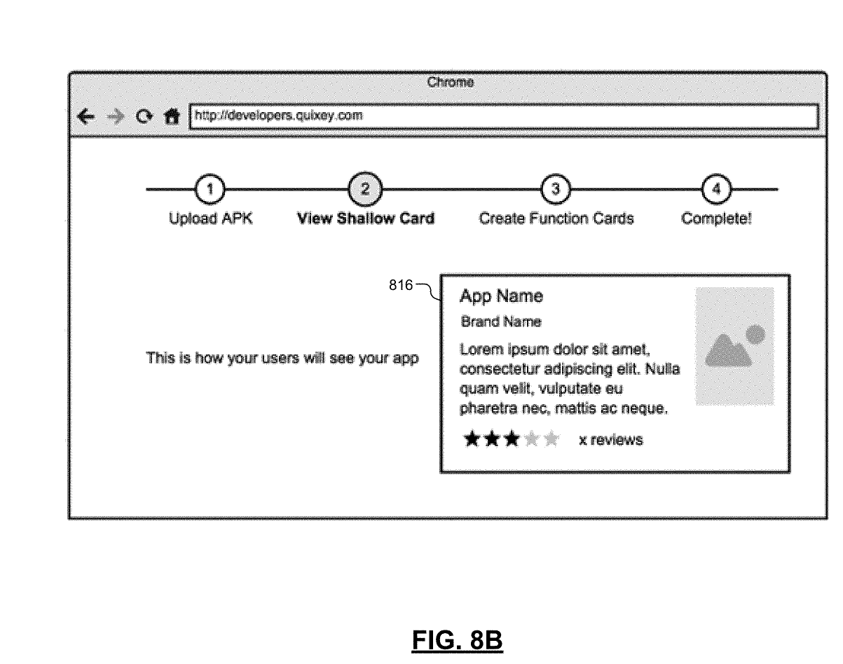

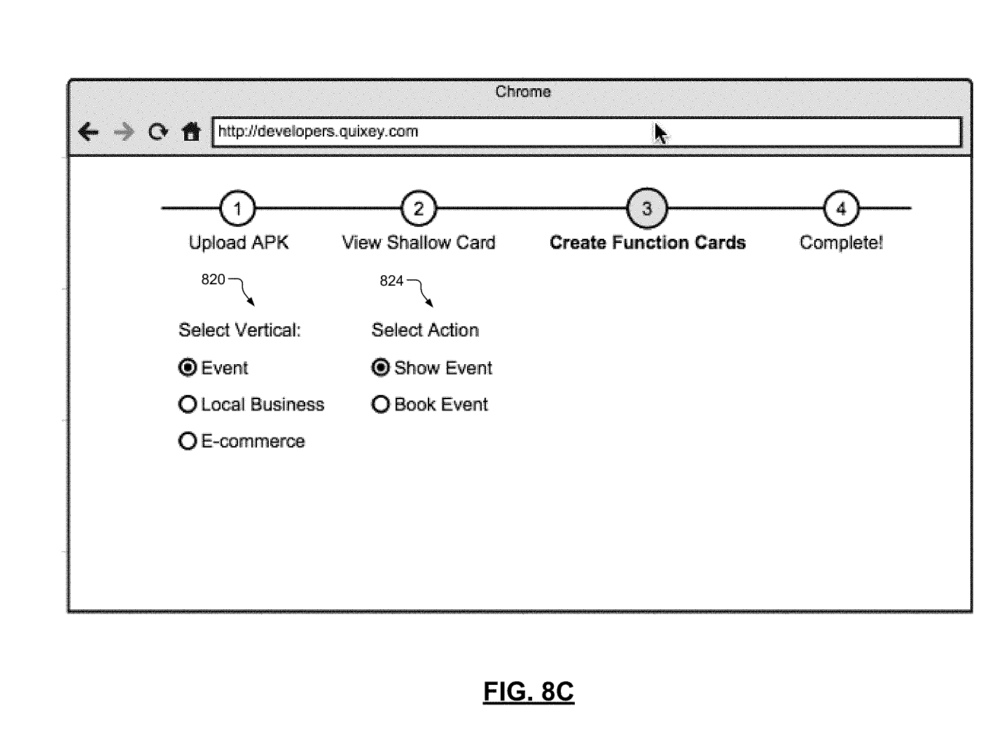

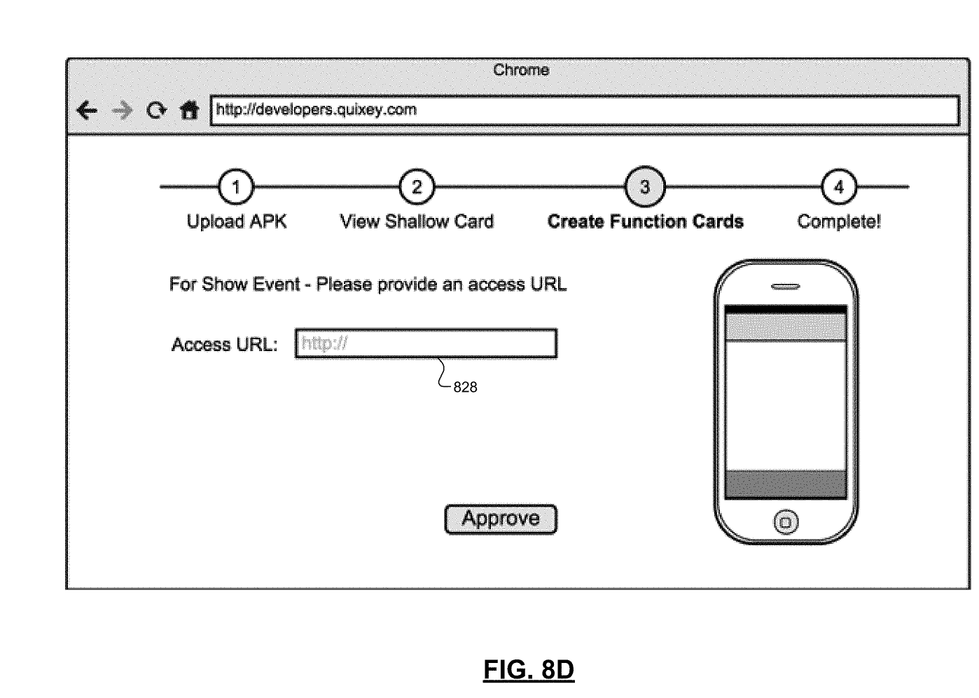

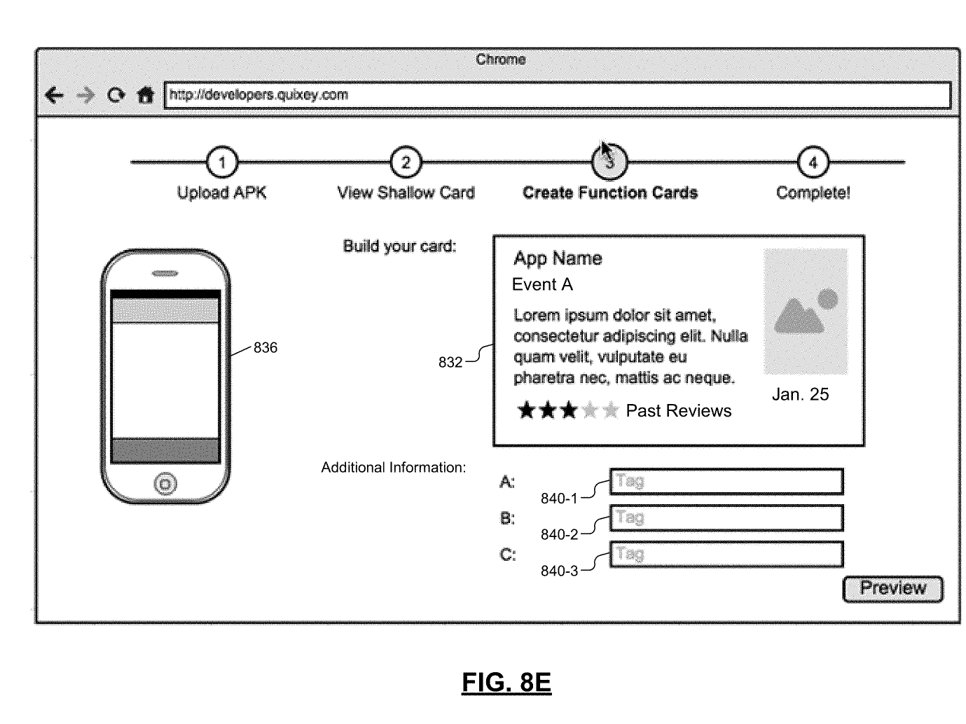

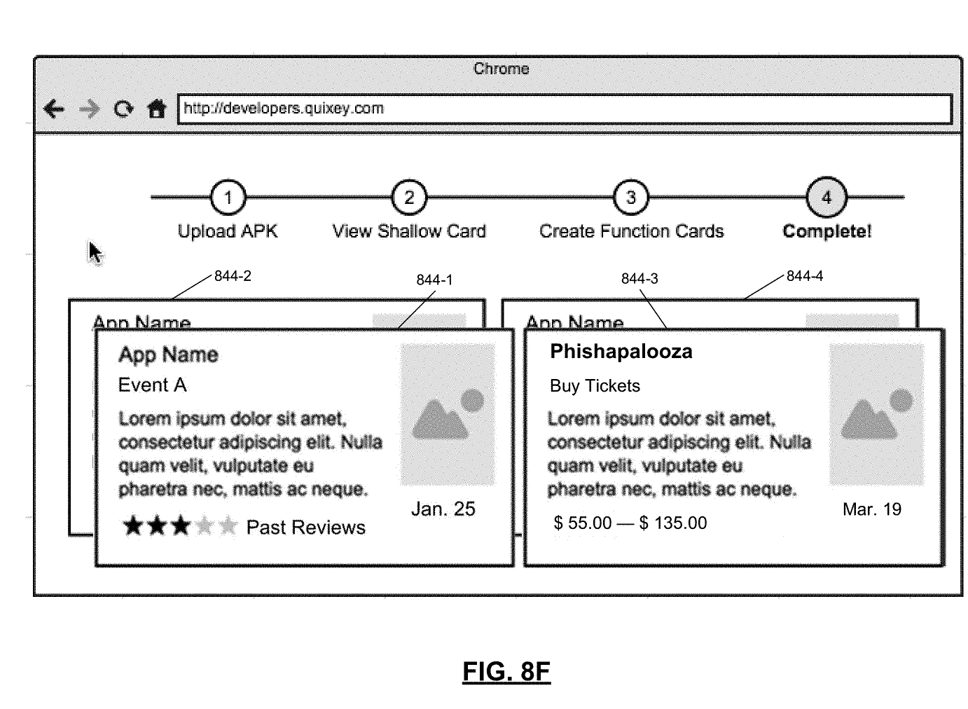

FIGS. 8A-8F are example models of a simplified user interface for the developer portal 124. As depicted, the developer portal 124 may be implemented as a website and may be available over the Internet. In FIG. 8A, a completion timeline 800 indicates to the developer how far they have progressed and a preview of the remaining steps. With shading, a first step 804 is indicated as the present step. At 808, the developer is allowed to supply a URL or local file location for an application package. Although referred to as an APK, a package for another operating system (such as iOS from Apple Inc.) may be uploaded. After actuating a button 810, the developer may be directed to the next screen.

In FIG. 8B, an app card is displayed. The app card may be generated based on data obtained from a digital distribution platform based on the URL provided in FIG. 8A. The developer may indicate their approval of the app card, causing a transition to the next screen.

In FIG. 8C, the developer specifies a vertical at 820. Based on the selected vertical, a corresponding list of actions 824 is presented for developer selection.

In FIG. 8D, the developer can specify an access URL for the action at 828.

In FIG. 8E, the developer may be permitted to modify a deep view card 832 for the action. For example only, a screenshot 836 of an example app state may be displayed to the developer. The developer can then drag and drop elements of the screenshot onto the deep view card 832. In other implementations, the developer can select (click) an element of the screenshot and then select (click) a corresponding location in the deep view card 832 where the element should be placed. As shown in FIG. 8E, as each element is added to the deep view card 832, the element may be removed from the screenshot 836 so that the same element is not used more than once. As shown in FIG. 8E, all of the elements of the screenshot 836 have been supplied to the deep view card 832 or attached as additional information at 840-1, 840-2, and 840-3.

In FIG. 8F, a stack of cards created using a similar interface to that shown in FIGS. 8C-8E, is shown. Deep view cards 844-1, 844-2, 844-3, and 844-4 are displayed to the developer for approval.

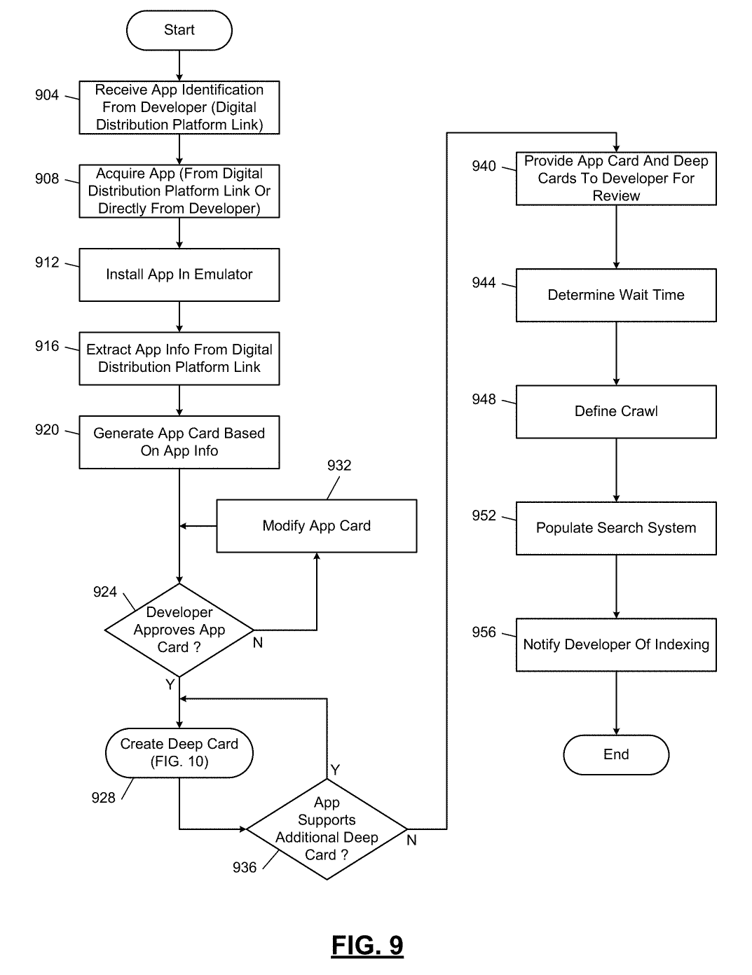

In FIG. 9, control begins when a developer has logged in and indicated an intent to specify a new app for onboarding to the developer portal. Control begins at 904, where the developer portal receives an identification of the app from a developer, which may take the form of a link to the app in a digital distribution platform. At 908, control acquires the app, either from the digital distribution link or directly from the developer. When acquiring the app from the developer, control may verify that the app (or a hash or other signature of the app) matches what is stored in a digital distribution platform.

At 912, control begins the installation process of the app into an emulator running an operating system that supports the app. At 916, control extracts information for the app from the digital distribution platform. At 920, control generates an app card based on the extracted app information. At 924, control presents the proposed app card to the developer. If the developer approves the app card, control allows the developer to create a deep card at 928; otherwise, control transfers to 932. At 932, the developer is given the opportunity to modify the app card, which may include moving and reformatting elements. Control then continues at 924.

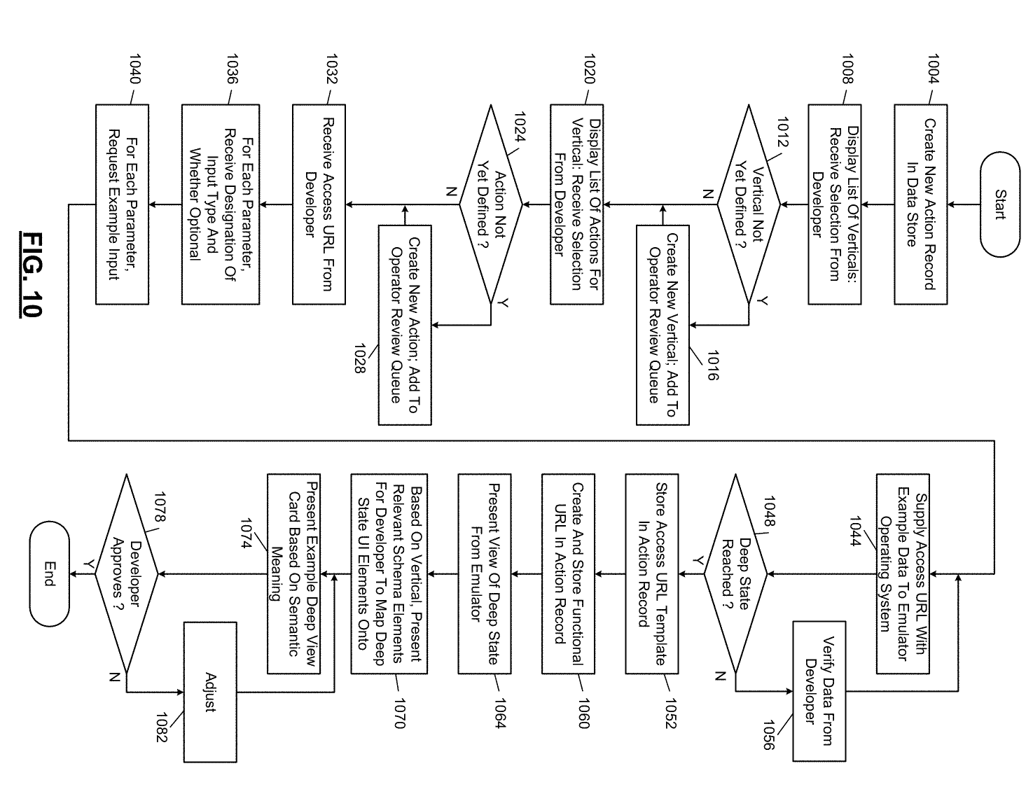

At 928, control allows the developer to create a deep card, such as by using the process shown in FIG. 10. After a deep card is created control continues at 936, where if the developer indicates that the app supports one or more additional deep cards, control returns to 928. Otherwise, control continues at 940. At 940, control provides the app card and deep cards to the developer for a final review.

At 944, control determines what the expected wait time will be before the search engine will begin showing results from the app. This way time may be shown to the developer. At 948, control defines a crawl of the app to retrieve data from, for each of the deep cards, all of the associated states. For example, this may require a heuristic process or a skilled operator. For example, when defining a crawl for a restaurant review application, the operator may determine that a search can be performed for restaurants based on location. By iterating through each zip code in the U.S., the app will return a corresponding list of U.S. restaurants, which can be crawled to obtain state data for a restaurant review deep state card.

At 952, control may begin populating the search system based on the crawl. In other implementations, a crawl may be performed and reviewed by an operator before being added to the search system. At 956, control optionally notifies the developer that the app has been indexed and will begin providing results from the app in response to user queries. Control then ends, pending another app being onboarded by this or another developer.

In FIG. 10, control begins at 1004, where a new action record is created in the data store. For example only, this may be the access URL templates data store 648 of FIG. 6. At 1008, control displays a list of the verticals from which the developer selects a vertical. For example only, these verticals may be established by schema.org and, for example, may include event, e-commerce, education, and local.

At 1012, if the developer-specified vertical is not yet defined, control transfers to 1016; otherwise, control transfers to 1020. At 1016, control creates a new vertical, such as in the schema data store 652 of FIG. 6. Each new vertical may be reviewed by an operator, who may review new verticals in an operator review queue. Verticals determined to be duplicative of previous verticals may be merged and previously unrecognized verticals may be characterized, renamed, and categorized in a hierarchal tree. Control then continues at 1020.

At 1020, control displays a list of actions corresponding to the selected vertical. The developer selects one of the actions or specifies a new action. At 1024, if the developer-specified action has not yet been defined, control transfers to 1028; otherwise, control continues at 1032. At 1028, control creates a new action for the selected vertical and adds the new action to an operator review queue. Control then continues at 1032.

At 1032, control prompts the developer for, and receives, an access URL for the action. At 1036, control requests that the developer specify which parameters are contained within the access URL. For each parameter, the developer specifies what input should be provided for that parameter and may provide additional information, such as whether that parameter is optional. Control continues at 1040, where for each parameter, control requests example data.

At 1044, using the example data, control instantiates an access URL by providing the example data into the parameters of the specified access URL. This access URL is provided to the operating system of the emulator, which passes the access URL to the developer's app. The developer's app interprets the access URL provided by the operating system and transitions to the specified state. At 1048, control verifies that the deep state expected for the access URL has been reached. If so, control transfers to 1052; otherwise, control transfers to 1056.

At 1056, control verifies the access URL, parameter data, and test data from the developer and allows the developer to make changes. Control then returns to 1044. If the deep state has not been reached after a predetermined number of attempts, control may exit from FIG. 10.

At 1052, control stores the parameterized access URL (also referred to an access URL template) in the action record created in 1004. At 1060, control creates a functional URL corresponding to the access URL template and stores the functional URL in the action record. At 1064, control presents a view of the deep state of the app as seen in the emulator.

At 1070, control presents a relevant schema to the developer. The schema may be based on the selected vertical and may be based on the selected action. The schema includes semantic tags relevant to the vertical. For example, a restaurant vertical may have been schema tags for restaurant name, cuisine, price, numeric review, text review, food image, logo, external photo, indoor photo, etc.

The developer then maps UI elements from the deep state onto the semantic tags. This may be performed using a graphical user interface and may include clicking and dragging UI elements onto schema tags or vice versa. The developer may also drag UI elements onto a deep view card template to indicate how a search result should appear for this deep state. The developer may also be able to set location, sizing, and formatting characteristics.

At 1074, control presents an example deep view card to the developer based on the specified semantic meaning. At 1078, if the developer approves of the example deep view card, control ends. Otherwise, control transfers to 1082. At 1082, control allows the developer to adjust the deep view card, such as by adding or removing fields and applying formatting properties. Control then returns to 1074.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

1. A search system comprising:
a user interface configured to receive information about a first application from a developer of the first application;
a state access module, including a hardware processor and memory, configured to obtain information about a first type of state of the first application from the developer via the user interface, wherein:
the obtained information includes an action performed by the first type of state of the first application;
the obtained information includes a first access uniform resource locator (URL) template that includes a string literal and a set of parameters;
the first access URL template defines an access URL by combining the string literal and specific strings corresponding to a set of specific values of the set of parameters; and
the first application is configured to display a specific state of the first type of state in response to receiving the access URL formed by instantiating the first access URL template with at least one value for the at least one parameter;
an emulator configured to:
execute a copy of the first application;
send a first access URL to the first application, wherein the first access URL is formed by instantiating the first access URL template with test data; and
obtain information about a resulting state of the first application, wherein the state access module is further configured to verify that the resulting state is the first type of state based on the information obtained about the resulting state from the emulator; and
a search engine configured to obtain data from the first application according to the information about the first type of state and selectively provide the obtained data in response to a query from a user of the search system.

2. The search system of claim 1 wherein:
the query from the user is an implicit query derived from content with which the user is interacting; and
the search engine is configured to transmit an advertisement to the user based on the obtained data.

3. The search system of claim 1 further comprising a crawler configured to:
determine a set of access URLs, each access URL of the set being an instantiation of the first access URL template with different values for the at least one parameter;
acquire content from each of the set of access URLs; and
store the content in a data store, wherein the search engine consults the data store to respond to the queries from the users of the search system.

4. The search system of claim 1 wherein:
the emulator is configured to provide information about user interface (UI) elements from the resulting state to the user interface; and
the search system further comprises a state mapping module configured to receive data from the developer indicating which ones of the UI elements to include in a search result for the resulting state sent to the users of the search system.

5. The search system of claim 4 wherein the state mapping module is configured to:
generate a preview of a search result for the resulting state, wherein the search result includes text and at least one image corresponding to the resulting state; and
provide the preview to the developer for approval.

6. The search system of claim 4 wherein the state mapping module is configured to receive semantic meaning information from the developer for at least one of the UI elements.

7. The search system of claim 1 wherein the state access module is configured to:
obtain a specification of an industry vertical for the first type of state of the first application;
select a predetermined set of actions according to the specified industry vertical; and
present the predetermined set of actions to the developer for selection of the action.

8. The search system of claim 1 further comprising a digital distribution platform interface configured to acquire information about the first application from a digital distribution platform.

9. The search system of claim 8 further comprising:
an application management module configured to generate a search result for the first application based on the information about the first application,
wherein the search result includes text and at least one image, and
wherein the search engine is configured to selectively provide the search result for the first application in response to the first application being relevant to a query.

10. The search system of claim 9 wherein:
the application management module is configured to provide a preview of the search result to the developer for approval; and
the digital distribution platform interface is configured to acquire the copy of the first application from the digital distribution platform.

11. A method of operating a search system, the method comprising:
receiving information about a first application from a developer of the first application through a user interface;
obtaining information about a first type of state of the first application from the developer via the user interface, wherein:
the obtained information includes an action performed by the first type of state of the first application;
the obtained information includes a first access uniform resource locator (URL) template that includes a string literal and a set of parameters;
the first access URL template defines an access URL by combining the string literal and specific strings corresponding to a set of specific values of the set of parameters; and
the first application is configured to display a specific state of the first type of state in response to receiving the access URL formed by instantiating the first access URL template with at least one value for the at least one parameter;
executing a copy of the first application;
sending a first access URL to the copy of the first application, wherein the first access URL is formed by instantiating the first access URL template with test data;
obtaining information about a resulting state of the first application;
verifying that the resulting state is the first type of state based on the information about the resulting state; and
in response to a query from a user of the search system, (i) obtaining data from the first application according to the information about the first type of state and (ii) selectively providing the obtained data to the user.

12. The method of claim 11 wherein:
the query from the user is an implicit query derived from content with which the user is interacting; and
the providing the obtained data includes transmitting an advertisement to the user based on the obtained data.

13. The method of claim 11 further comprising:
determining a set of access URLs, each access URL of the set being an instantiation of the first access URL template with different values for the at least one parameter;
acquiring content from each of the set of access URLs; and
storing the content in a data store,
wherein the providing the obtained data to the user includes consulting the data store.

14. The method of claim 11 further comprising:
providing information about user interface (UI) elements from the resulting state to the user interface; and
receiving data from the developer indicating which ones of the UI elements to include in a search result for the resulting state sent to the user of the search system.

15. The method of claim 14 further comprising:
generating a preview of a search result for the resulting state, wherein the search result includes text and at least one image corresponding to the resulting state; and
providing the preview to the developer for approval.

16. The method of claim 14 further comprising receiving semantic meaning information from the developer for at least one of the UI elements.

17. The method of claim 11 further comprising:
obtaining a specification of an industry vertical for the first type of state of the first application;
selecting a predetermined set of actions according to the specified industry vertical; and
presenting the predetermined set of actions to the developer for selection of the action.

18. The method of claim 11 further comprising acquiring information about the first application from a digital distribution platform.

19. The method of claim 18 further comprising:
generating a search result for the first application based on the information about the first application, wherein the search result includes text and at least one image; and
selectively providing the search result for the first application to a user in response to the first application being relevant to a query from the user.

20. The method of claim 19 further comprising:
providing a preview of the search result to the developer for approval; and
acquiring the copy of the first application from the digital distribution platform.
